(19) United States
(12) Patent Application Publication
(10) Pub. No.: US 2022/0121571 A1
(43) Pub. Date: Apr. 21, 2022

(54) CROSS-BLADE CACHE SLOT DONATION

(71) Applicant: EMC IP HOLDING COMPANY LLC, Hopkinton, MA (US)

(72) Inventors: John Creed, Innishannon (IE); Steve Ivester, Worcester, MA (US); John Krasner, Coventry, RI (US); Kaustubh Sahasrabudhe, Westborough, MA (US)

(73) Assignee: EMC IP HOLDING COMPANY LLC, Hopkinton, MA (US)

(21) Appl. No.: 17/074,936

(22) Filed: Oct. 20, 2020

(51) Int. Cl. G06F 12/084; G06F 12/0871; G06F 12/06; G06F 15/173; G06F 9/30; G06F 9/54

(52) U.S. Cl. CPC G06F 12/084; G06F 12/0871; G06F 12/063; G06F 9/544; G06F 9/3009; G06F 9/546; G06F 9/542; G06F 15/17331

(57) ABSTRACT

Remote cache slots are donated in a storage array without requiring a cache slot starved compute node to search for candidates in remote portions of a shared memory. One or more donor compute nodes create donor cache slots that are reserved for donation. The cache slot starved compute node broadcasts a message to the donor compute nodes indicating a need for donor cache slots. The donor compute nodes provide donor cache slots to the cache slot starved compute node in response to the message. The message may be broadcast by updating a mask of compute node operational status in the shared memory. The donor cache slots may be provided by providing pointers to the donor cache slots.

### TECHNICAL FIELD

The subject matter of this disclosure is generally related to electronic data storage systems and more particularly to shared memory in such systems.

### BACKGROUND

High capacity data storage systems such as storage area networks (SANs) are used to maintain large data sets and contemporaneously support multiple users. A storage array, which is an example of a SAN, includes a network of interconnected compute nodes that manage access to data stored on arrays of drives. The compute nodes access the data in response to input-output commands (IOs) from host applications that typically run on servers known as “hosts.” Examples of host applications may include, but are not limited to, software for email, accounting, manufacturing, inventory control, and a wide variety of other business processes. The IO workload on the storage array is normally distributed among the compute nodes such that individual compute nodes are each able to respond to IOs with no more than a target level of latency. However, unbalanced IO workloads and resource allocations can result in some compute nodes being overloaded while other compute nodes have unused memory and processing resources.

### SUMMARY

In accordance with some implementations an apparatus comprises: a data storage system comprising: a plurality of non-volatile drives; and a plurality of interconnected compute nodes that present at least one logical production volume to hosts and manage access to the drives, each of the compute nodes comprising a local memory and being configured to allocate a portion of the local memory to a shared memory that can be accessed by each of the compute nodes, the shared memory comprising cache slots that are used to store data for servicing input-output commands (IOs); wherein a first one of the compute nodes is configured to create donor cache slots that are available for donation to other ones of the compute nodes, a second one of the compute nodes is configured to generate a message that indicates a need for donor cache slots, and the first compute node is configured to provide at least some of the donor cache slots to the second compute node in response to the message, whereby the second compute node acquires remote donor cache slots without searching for candidates in remote portions of the shared memory.

In accordance with some implementations a method for acquiring remote donor cache slots without searching for candidates in remote portions of a shared memory in a data storage system comprising a plurality of non-volatile drives and a plurality of interconnected compute nodes that present at least one logical production volume to hosts and manage access to the drives, each of the compute nodes comprising a local memory and being configured to allocate a portion of the local memory to the shared memory that can be accessed by each of the compute nodes, the shared memory comprising cache slots that are used to store data for servicing input-output commands (IOs) comprises: a first one of the compute nodes creating donor cache slots that are available for donation to other ones of the compute nodes; a second one of the compute nodes generating a message that indicates a need for donor cache slots; and the first compute node providing at least some of the donor cache slots to the second compute node in response to the message.

In accordance with some implementations a computer-readable storage medium stores instructions that when executed by a compute node cause the compute node to perform a method for acquiring remote donor cache slots without searching for candidates in remote portions of a shared memory in a data storage system comprising a plurality of non-volatile drives and a plurality of interconnected compute nodes that present at least one logical production volume to hosts and manage access to the drives, each of the compute nodes comprising a local memory and being configured to allocate a portion of the local memory to the shared memory that can be accessed by each of the compute nodes, the shared memory comprising cache slots that are used to store data for servicing input-output commands (IOs), the method comprising: creating donor cache slots that are available for donation to ones of the compute nodes; generating a message that indicates a need for donor cache slots; and providing at least some of the donor cache slots to the second compute node in response to the message.

### BRIEF DESCRIPTION OF THE FIGURES

FIG. 1 illustrates a storage array in which a Cache_Donation_Source Board-Mask is used for requesting and donating remote cache slots.

FIG. 2 illustrates how shared memory is used to service IOs.

FIG. 3 illustrates cache slot donation between compute nodes.

FIG. 4 illustrates steps associated with creation of donor cache slots.

FIG. 5 illustrates steps associated with operation of a cache slot donor target.

FIG. 6 illustrates steps associated with operation of a cache slot donor source.

### DETAILED DESCRIPTION

All examples, aspects, and features mentioned in this disclosure can be combined in any technically possible way. The terminology used in this disclosure is intended to be interpreted broadly within the limits of subject matter eligibility. The terms “disk” and “drive” are used interchangeably herein and are not intended to refer to any specific type of non-volatile electronic storage media. The terms “logical” and “virtual” are used to refer to features that are abstractions of other features, e.g. and without limitation abstractions of tangible features. The term “physical” is used to refer to tangible features that possibly include, but are not limited to, electronic hardware. For example, multiple virtual computers could operate simultaneously on one physical computer. The term “logic,” if used herein, refers to special purpose physical circuit elements, firmware, software, computer instructions that are stored on a non-transitory computer-readable medium and implemented by multi-purpose tangible processors, alone or in any combination. Aspects of the inventive concepts are described as being implemented in a data storage system that includes host servers and a storage array. Such implementations should not be viewed as limiting. Those of ordinary skill in the art will recognize that there are a wide variety of implementations of the inventive concepts in view of the teachings of the present disclosure.

Some aspects, features, and implementations described herein may include machines such as computers, electronic components, optical components, and processes such as computer-implemented procedures and steps. It will be apparent to those of ordinary skill in the art that the computer-implemented procedures and steps may be stored as computer-executable instructions on a non-transitory computer-readable medium. Furthermore, it will be understood by those of ordinary skill in the art that the computer-executable instructions may be executed on a variety of tangible processor devices, i.e. physical hardware. For practical reasons, not every step, device, and component that may be part of a computer or data storage system is described herein. Those of ordinary skill in the art will recognize such steps, devices, and components in view of the teachings of the present disclosure and the knowledge generally available to those of ordinary skill in the art. The corresponding machines and processes are therefore enabled and within the scope of the disclosure.

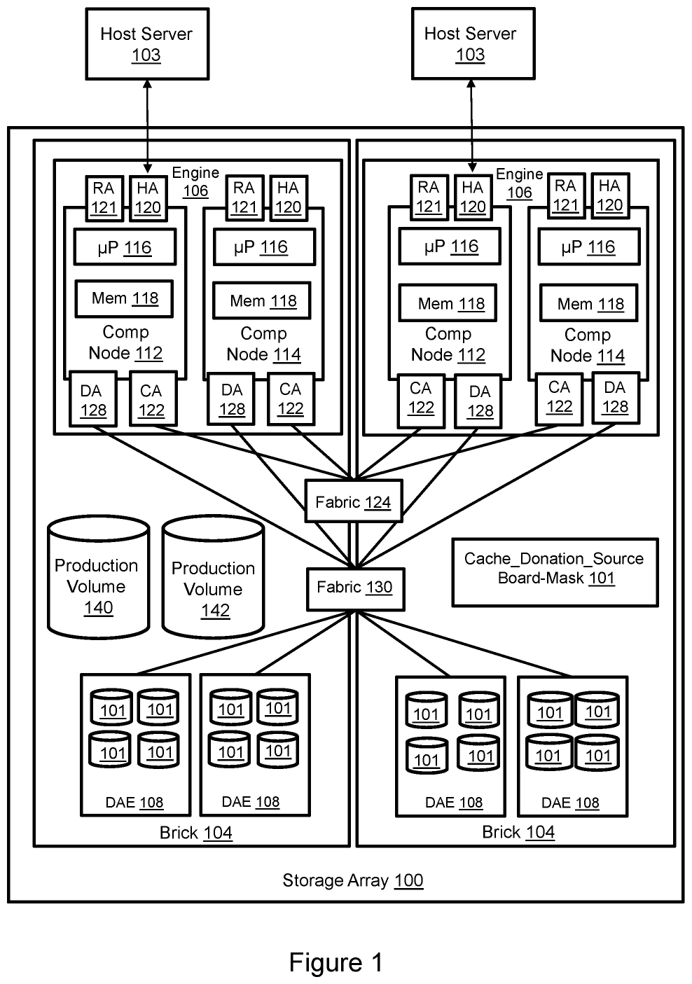

FIG. 1 illustrates a storage array 100 in which a Cache_Donation_Source Board-Mask 101 is used for requesting and donating remote cache slots. Typical prior art designs require a compute node that has exhausted its local cache slots to search for remote cache slots on other compute nodes, which is problematic because the search consumes scarce resources such as volatile memory that could be used for local cache slots. The Cache_Donation_Source Board-Mask enables a cache slot starved compute node to broadcast a message to other compute nodes to indicate a need for remote cache slots. Cache slot donor compute nodes respond to the message by providing remote cache slots to the cache slot starved compute node, thereby reducing the resource burden on the cache slot starved compute node. The donated remote cache slots are created before the message is generated so there is little latency between broadcast of the message and utilization of the remote cache slots.

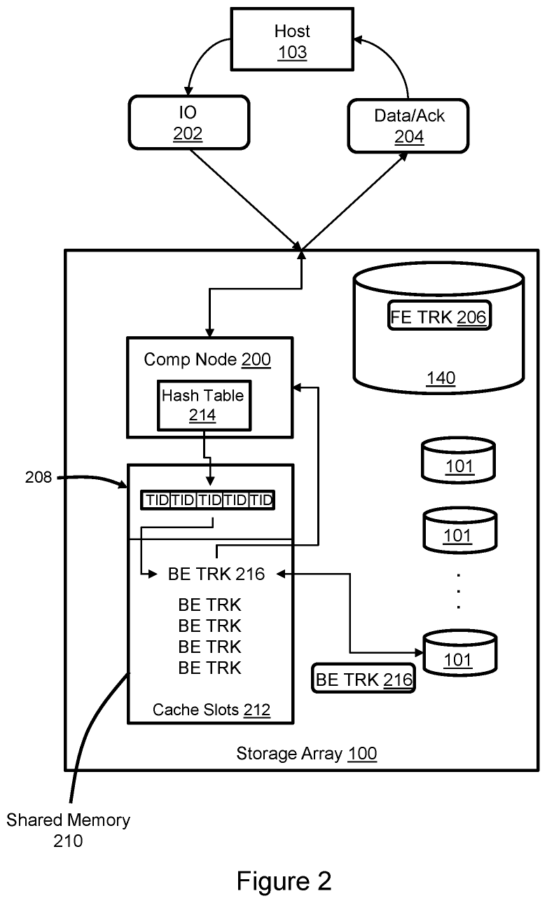

The storage array 100, which is depicted in a simplified data center environment with two host servers 103 that run host applications, is one example of a storage area network (SAN). The host servers 103 may be implemented as individual physical computing devices, virtual machines running on the same hardware platform under control of a hypervisor, or in containers on the same hardware platform. The storage array 100 includes one or more bricks 104. Each brick includes an engine 106 and one or more drive array enclosures (DAEs) 108. Each engine 106 includes a pair of interconnected compute nodes 112, 114 that are arranged in a failover relationship and may be referred to as “storage directors” or simply “directors.” Although it is known in the art to refer to the compute nodes of a SAN as “hosts,” that naming convention is avoided in this disclosure to help distinguish the network server hosts 103 from the compute nodes 112, 114. Nevertheless, the host applications could run on the compute nodes, e.g. on virtual machines or in containers. Each compute node includes resources such as at least one multi-core processor 116 and local memory 118. The processor may include central processing units (CPUs), graphics processing units (GPUs), or both. The local memory 118 may include volatile media such as dynamic random-access memory (DRAM), non-volatile memory (NVM) such as storage class memory (SCM), or both. Each compute node allocates a portion of its local memory 118 to a shared memory 210 (FIG. 2) that can be accessed by any compute node in the storage array using direct memory access (DMA) or remote direct memory access (RDMA). Each compute node includes one or more host adapters (HAs) 120 for communicating with the host servers 103. Each host adapter has resources for servicing input-output commands (IOs) from the host servers. The HA resources may include processors, volatile memory, and ports via which the host servers may access the storage array. Each compute node also includes a remote adapter (RA) 121 for communicating with other storage systems. Each compute node also includes one or more drive adapters (DAs) 128 for communicating with managed drives 101 in the DAEs 108. Each DA has processors, volatile memory, and ports via which the compute node may access the DAEs for servicing IOs. Each compute node may also include one or more channel adapters (CAs) 122 for communicating with other compute nodes via an interconnecting fabric 124. The managed drives 101 are non-volatile electronic data storage media such as, without limitation, solid-state drives (SSDs) based on electrically erasable programmable read-only memory (EEPROM) technology such as NAND and NOR flash memory and hard disk drives (HDDs) with spinning disk magnetic storage media. Drive controllers may be associated with the managed drives as is known in the art. An interconnecting fabric 130 enables implementation of an N-way active-active back end. A back-end connection group includes all drive adapters that can access the same drive or drives. In some implementations every DA 128 in the storage array can reach every DAE via the fabric 130. Further, in some implementations every DA in the storage array can access every managed drive 101.

Data associated with instances of a host application running on the hosts 103 is maintained persistently on the managed drives 101. The managed drives 101 are not discoverable by the hosts 103 but the storage array creates logical storage devices known as production volumes 140, 142 that can be discovered and accessed by the hosts. Without limitation, a production volume may alternatively be referred to as a storage object, source device, production device, or production LUN, where the logical unit number (LUN) is a number used to identify logical storage volumes in accordance with the small computer system interface (SCSI) protocol. From the perspective of the hosts 103, each production volume 140, 142 is a single drive having a set of contiguous fixed-size logical block addresses (LBAs) on which data used by the instances of the host application resides. However, the host application data is stored at non-contiguous addresses on various managed drives 101, e.g. at ranges of addresses distributed on multiple drives or multiple ranges of addresses on one drive. The compute nodes maintain metadata that maps between the production volumes 140, 142 and the managed drives 101 in order to process IOs from the hosts.

FIG. 2 illustrates how the shared memory 210 is used to service IOs when compute node 112 receives an IO 202 from host 103. The IO 202 may be a Write command or a Read command. A response 204 to the IO 202 is an Ack in the case of a Write command and data in the case of a Read command. The description below is for the case in which the IO 202 is a Read to a front-end track (FE TRK) 206 that is logically stored on production volume 140. Metadata is maintained in track ID tables (TIDs) that are located in an allocated portion 208 of shared memory 210. The TIDs include pointers to cache slots 212 that contain back-end tracks (BE TRKs) of host application data. The cache slots are located in another allocated portion of the shared memory 210. The compute node 200 identifies a TID corresponding to FE TRK 206 by inputting information such as the device number, cylinder number, head (track) and size obtained from the IO into a hash table 214. The hash table 214 indicates the location of the TID in the shared memory 210. The TID is obtained and used by the compute node 200 to find the corresponding cache slot that contains a BE TRK 216 associated with FE TRK 206. The BE TRK 216 is not necessarily present in the cache slots 212 when the IO is received because the managed drives 101 have much greater storage capacity than the cache slots and IOs are serviced continuously. If the corresponding BE TRK 216 is not present in the cache slots 212, then the compute node 200 locates and copies the BE TRK 216 from the managed drives 101 into an empty cache slot. In the case of a Read the FE TRK data specified by the IO 202 is obtained from the BE TRK 216 in the cache slots and a copy of the data is sent to the host 103. In the case of a Write the FE TRK data is copied into the BE TRK in the cache slots and eventually destaged to the managed drives 101, e.g. overwriting the stale copy on the managed drives. Regardless of whether the IO is a Read or a Write, the condition in which the BE TRK is already present in the cache slots when the IO is received is referred to as a “cache hit” and the condition in which the BE TRK is not in the cache slots when the IO is received is referred to as a “cache miss.”

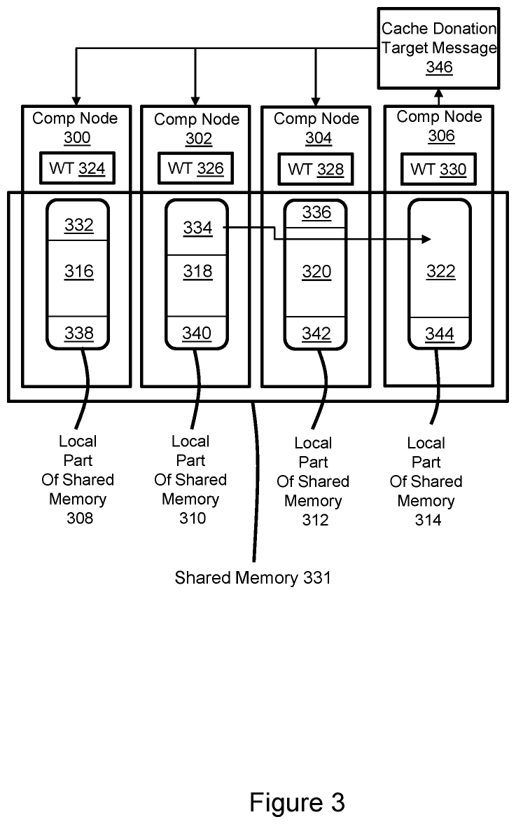

FIG. 3 illustrates cache slot donation between four compute nodes 300, 302, 304, 306. Shared memory 331 includes portions 308, 310, 312, 314 of the local memory respectively of compute nodes 300, 302, 304, 306. A part of each local portion of the shared memory is allocated for use as cache slots. Local cache slots 316, 318, 320, 322 respectively are the allocated parts of local memory portions 308, 310, 312, 314 of respective compute nodes 300, 302, 304, 306. Although any compute node can access the cache slots of any other compute node in the shared memory there is a bias in favor of compute nodes using local cache slots because of lower access latency. Consequently, each compute node uses its local cache slots to service the incoming IOs received by that compute node. As new IOs are received it is necessary to free local cache slots by recycling cache slots that are in use. Cache slot recycling normally requires at least two blocking operations to be performed by critical IO threads: searching for a candidate cache slot to be flushed or destaged; and unbinding or disassociating a selected candidate cache slot from its current TID. In the illustrated storage array worker threads 324, 326, 328, 330 running respectively on each of the compute nodes 300, 302, 304, 306 recycle local cache slots by destaging dirty (changed) data to the managed drives, flushing unchanged data from shared memory, and disassociating the cache slot from its current TID. For example, each worker thread may iteratively select the least recently accessed local cache slots for recycling. The number and rate of slots recycled by the worker threads may be dynamically adjusted to maximize the amount of time a BE TRK stays in the cache slots and to reduce time of residence in the allocation queue. However, unbalanced or bursty IO workloads and different resource allocations can still result in some compute nodes becoming overloaded while other compute nodes have unused resources. For example, if the local part of the shared memory of compute node 306 is smaller than the local parts of other compute nodes or the worker threads cannot recycle local cache slots of compute node 306 quickly enough to meet a burst of IO demand then the need for cache slots may outpace the supply of local cache slots for compute node 306, in which case remote cache slots may be acquired by compute node 306 as will be described below.

Donor cache slots are created and held in reserve by compute nodes based on operational status. Each compute node 300, 302, 304, 306 maintains operational status metrics 338, 340, 342, 344 such as one or more of recent cache slot allocation rate, current number of write pending or dirty cache slots, current depth of local shared slot queues, and recent fall-through time (FTT). The recent cache slot allocation rate indicates how many local cache misses occurred within a predetermined window of time, e.g. the past S seconds or M minutes. The current number of write pending (WP) or dirty cache slots indicates how many of the local cache slots contain changed data that must be destaged to the managed drives before the associated cache slot can be recycled. A smaller number indicates better suitability for creation of donor cache slots. The current depth of the local shared slot queues indicates the number of free cache slots required to service new IOs. The depth of the local shared slot queues also indicates the state of the race condition that exists between worker thread recycling and IO workload. A shorter depth indicates better suitability for creation of donor cache slots. Recent FTT indicates the average time that BE TRKs are resident in the local cache slots before being recycled, e.g. time between being written to a cache slot and being flushed or destaged from the cache slot by a worker thread. A larger FTT indicates better suitability for creation of donor cache slots.

The operational status metrics 338, 340, 342, 344 are captured and written by the worker thread of each compute node to the shared memory 210 and used to calculate how many donor cache slots, if any, to create. In the illustrated example compute nodes 300, 302, and 328 each generate a different quantity of donor cache slots 332, 334, 336 based on local operational status while cache slot starved compute node 306 has no donor cache slots. The operational status information and donor cache slot information collectively form part of the Cache_Donation_Source Board-Mask. The cache slot starved compute node 306 generates a cache slot donation target message 346 that is broadcast to the other compute nodes 300, 302, 304. The message may be broadcast by writing to the Cache_Donation_Source Board-Mask. In response to the message, one or more of the potential remote cache slot donor compute nodes provides remote cache slots to the cache slot starved compute node 306. In the illustrated example compute node 302 is shown donating remote cache slots to compute node 306. Donation of remote cache slots may include providing pointers to the locations of the remote cache slots in the shared memory. The remote cache slots can be accessed by the cache slot starved compute node 306 using DMA or RDMA. The local worker thread for the remote cache slot, e.g. WT 326 for the remote cache slots donated by compute node 302, eventually recycles the donated remote cache slots.

The number of cache slots to be queued as donor slots is limited to avoid degrading performance of the donor compute node. Capability to donate cache slots is based on per-director cache statistics, e.g. eliminating as candidates directors that have more than a predetermined number of WP, are above an 85% out of pool (dirty) slots limit, and have a local FTT that is below a predetermined level compared to the storage array average FTT for a specific segment. Per-director DSA statistics, pre-determined pass/fail criteria for each emulation on the director, max work queues or some other indicator of spare cycles, and per-slice DSA statistics for the remaining emulations may also be used. Director cache statistics are not necessarily static so the number of donor cache slots maintained by a director may be dynamically adjusted.

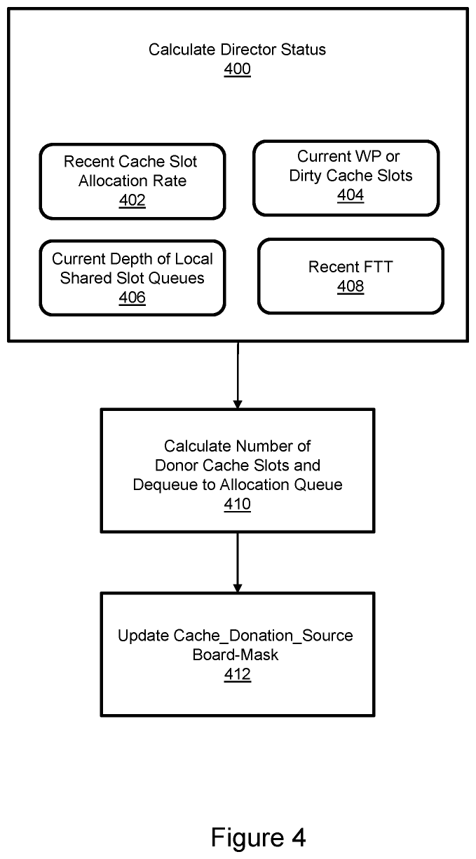

FIG. 4 illustrates steps associated with creation of donor cache slots. Each of the steps is implemented by each compute node (director) individually. Step 400 is calculating the operational status metrics. The step includes calculating one or more of recent cache slot allocation rate 402, current number of write pending or dirty cache slots 404, current depth of local shared slot queues 406, and recent FTT 408. Recent FTT may include one or more of director FTT, FTTs of individual cache segments, average FTT of the storage array, and out of pool slots counts on the boards. Step 410 is calculating the number of donor cache slots to create and hold in reserve. The donor cache slots are dequeued to an allocation queue of donor cache slots. Step 412 is updating the Cache_Donation_Source Board-Mask to indicate the calculated operational status metrics and number of donor cache slots.

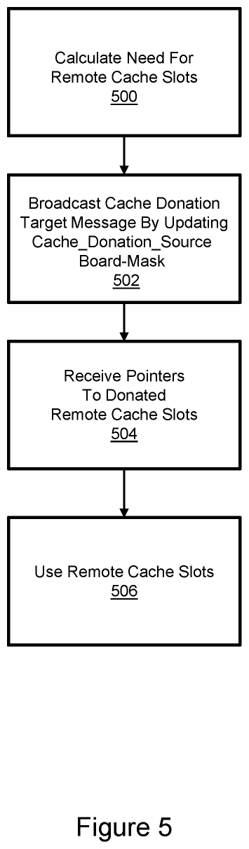

FIG. 5 illustrates steps associated with operation of a cache slot donor target. Step 500 is calculating the need for remote cache slots. The step may include detecting need based on a predetermined level of utilization of local cache slots and the operational status metrics. The step may also include calculating a number of remote cache slots needed. Step 502 is broadcasting a cache donation target message. The step may be implemented by updating the Cache_Donation_Source Board-Mask. Step 504 is receiving pointers to donated remote cache slots. The pointers are provided by remote cache slot donor compute nodes. Step 506 is using the donated remote cache slots to service IOs.

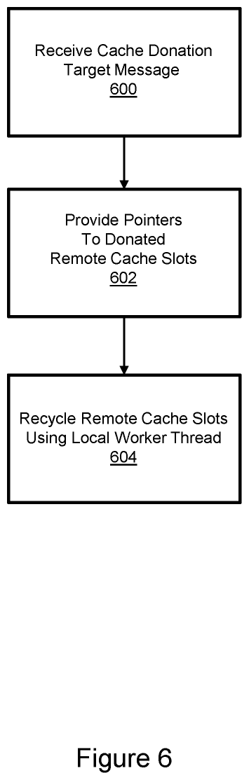

FIG. 6 illustrates steps associated with operation of a cache slot donor source. Step 600 is receiving a cache donation target message. The message may be received by detecting the update of the Cache_Donation_Source Board-Mask. Step 602 is providing pointers to donated remote cache slots. The pointers are provided to the cache slot donor target. The number of cache slots donated to the target may be determined based on the number of donor cache slots in the allocation queue and the number of remote cache slots requested by the cache slot donor target. Multiple cache slot donor source compute nodes may coordinate by updating a counter in shared memory that is initially set to the number of remote cache slots requested by the cache slot donor target. Each cache slot donor source compute node decrements the counter by the number of donated cache slots. Step 604 is recycling the remote cache slots. This may be performed by the local worker thread of the cache slot donor source compute node.

Specific examples have been presented to provide context and convey inventive concepts. The specific examples are not to be considered as limiting. A wide variety of modifications may be made without departing from the scope of the inventive concepts described herein. Moreover, the features, aspects, and implementations described herein may be combined in any technically possible way. Accordingly, modifications and combinations are within the scope of the following claims.

1. An apparatus comprising:
a data storage system comprising:
a plurality of non-volatile drives; and
a plurality of interconnected compute nodes that present at least one logical production volume to hosts and manage access to the drives, each of the compute nodes comprising a local memory and being configured to allocate a portion of that local memory to a shared memory that can be accessed by each of the compute nodes of the plurality of compute nodes, the shared memory comprising cache slots that are used to store logical production volume data for servicing input-output commands (IOs) to the logical production volume, the cache slots being accessible by each of the plurality of compute nodes;
wherein a first one of the compute nodes is configured to create donor cache slots that are available for donation to other ones of the compute nodes for storage of logical production volume data that is accessible by each of the plurality of compute nodes, a second one of the compute nodes is configured to generate a message that indicates a need for donor cache slots, and the first compute node is configured to provide at least some of the donor cache slots to the second compute node in response to the message,
whereby the second compute node acquires remote donor cache slots for storage of logical production volume data that is accessible by all of the compute nodes without searching for candidates in remote portions of the shared memory.

2. The apparatus of claim 1 wherein the first compute node is configured to provide the donor cache slots to the second compute node by providing pointers to the donor cache slots.

3. The apparatus of claim 2 wherein the data storage system further comprises a plurality of worker threads that maintain statistical data indicative of operational status of each of the compute nodes.

4. The apparatus of claim 3 wherein the statistical data comprises one or more of local cache slot allocation rate, current number of local dirty cache slots, current depth of local shared slot queues, and fall-through time (FTT).

5. The apparatus of claim 4 wherein the statistical data is maintained in a Cache_Donation_Source Board-Mask in the shared memory.

6. The apparatus of claim 5 wherein the message is broadcast by updating the Cache_Donation_Source Board-Mask in the shared memory.

7. The apparatus of claim 6 wherein the first compute node calculates a number of donor cache slots to create based on the statistical data.

8. A method for acquiring remote donor cache slots for storage of logical production volume data that is accessible by each of a plurality of interconnected compute nodes without searching for candidates in remote portions of a shared memory in a data storage system comprising a plurality of non-volatile drives, wherein the plurality of interconnected compute nodes present at least one logical production volume to hosts and manage access to the drives, each of the compute nodes comprising a local memory and being configured to allocate a portion of that local memory to the shared memory that can be accessed by each of the compute nodes, the shared memory comprising cache slots that are used to store logical production volume data for servicing input-output commands (IOs) to the logical production volume, the cache slots being accessible by each of the plurality of compute nodes, the method comprising:
a first one of the compute nodes creating donor cache slots that are available for donation to other ones of the compute nodes for storage of logical production volume data that is accessible by each of the plurality of compute nodes;
a second one of the compute nodes generating a message that indicates a need for donor cache slots; and
the first compute node providing at least some of the donor cache slots to the second compute node in response to the message.

9. The method of claim 8 comprising first compute node providing the donor cache slots to the second compute node by providing pointers to the donor cache slots.

10. The method of claim 9 comprising a plurality of worker threads maintaining statistical data indicative of operational status of each of the compute nodes.

11. The method of claim 10 wherein maintaining the statistical data comprises maintain one or more of local cache slot allocation rate, current number of local dirty cache slots, current depth of local shared slot queues, and fall-through time (FTT).

12. The method of claim 11 comprising maintain the statistical data in a Cache_Donation_Source Board-Mask in the shared memory.

13. The method of claim 12 comprising broadcasting the message by updating the Cache_Donation_Source Board-Mask in the shared memory.

14. The method of claim 13 comprising calculating a number of donor cache slots to create based on the statistical data.

15. A computer-readable storage medium storing instructions that when executed by a compute node cause the compute node to perform a method for acquiring remote donor cache slots for storage of logical production volume data that is accessible by each of a plurality of interconnected compute nodes without searching for candidates in remote portions of a shared memory in a data storage system comprising a plurality of non-volatile drives, wherein the plurality of interconnected compute nodes present at least one logical production volume to hosts and manage access to the drives, each of the compute nodes comprising a local memory and being configured to allocate a portion of the local memory to the shared memory that can be accessed by each of the compute nodes, the shared memory comprising cache slots that are used to store logical production volume data for servicing input-output commands (IOs) to the logical production volume, the cache slots being accessible by each of the plurality of compute nodes, the method comprising:
creating donor cache slots that are available for donation to ones of the compute nodes for storage of logical production volume data that is accessible by each of the plurality of compute nodes;
generating a message that indicates a need for donor cache slots; and
providing at least some of the donor cache slots to the second compute node in response to the message.

16. The computer-readable storage medium of claim 15 wherein the method comprises providing the donor cache slots by providing pointers to the donor cache slots.

17. The computer-readable storage medium of claim 16 wherein the method comprises a plurality of worker threads maintaining statistical data indicative of operational status of each of the compute nodes.

18. The computer-readable storage medium of claim 17 wherein maintaining the statistical data comprises maintaining one or more of local cache slot allocation rate, current number of local dirty cache slots, current depth of local shared slot queues, and fall-through time (FTT).

19. The computer-readable storage medium of claim 18 wherein the method comprises maintaining the statistical data in a Cache_Donation_Source Board-Mask in the shared memory.

20. The computer-readable storage medium of claim 19 wherein the method comprises broadcasting the message by updating the Cache_Donation_Source Board-Mask in the shared memory.
